(19) United States
(12) Patent Application Publication
(10) Pub. No.: US 2014/0359444 A1
(43) Pub. Date: Dec. 4, 2014

(54) STREAMING LIVE BROADCAST MEDIA

(71) Applicant: Escape Media Group, Inc., Gainesville, FL (US)

(72) Inventors: Josh Greenberg-Sanders, Gainesville, FL (US); Samuel Tarantino III, Long Island City, NY (US); Jason Paroline, Gainesville, FL (US); Dustin Pace, Gainesville, FL (US)

(73) Assignee: Escape Media Group, Inc., Gainesville, FL (US)

(21) Appl. No.: 14/292,362

(22) Filed: May 30, 2014

Related U.S. Application Data
(60) Provisional application No. 61/829,502, filed on May 31, 2013.

(51) Int. Cl. G06F 3/0484; H04L 12/58; H04L 29/06; G06F 3/16

(52) U.S. Cl. CPC G06F 3/0484; G06F 3/162; H04L 51/04; H04L 65/4076
USPC 715/716

(57) ABSTRACT

Technologies are generally described for a media service platform to stream broadcast media. A broadcaster may select media, such as audio and video recordings, to be included in a media broadcast. The media broadcast may be streamed to one or more subscribing users through one or more client devices over a network employing the media service platform. The subscribing users may be able to provide input and suggestions related to the streamed media through a broadcast page displayed on a user interface of the client devices. Additionally, the subscribing users may interact with each other and the broadcaster employing a real time discussion pane on the broadcast page. In some examples, the broadcaster may insert commentary and recordings concurrently with the streamed media broadcast. In other examples, the media broadcast may be saved and played again at a later time in part or in full.

### CROSS-REFERENCE TO RELATED APPLICATIONS

This application claims priority to U.S. Provisional Application Ser. No. 61/829,502 filed on May 31, 2013. The Provisional Application is herein incorporated by reference in its entirety.

### BACKGROUND

Unless otherwise indicated herein, the materials described in this section are not prior art to the claims in this application and are not admitted to be prior art by inclusion in this section.

Example digital music listening solutions may fall into a variety of categories, including traditional broadcast radio, on-demand music listening, internet radio, and social music sharing. On-demand music listening may enable a user to select a particular song to listen to and the song may be played in real-time. However, continuous streaming of a song may not be enabled. Internet radio may involve streaming media over the internet to listeners through an application, web browser, or similar interface executed on a client device such as a computer, smart phone, tablet, or other portable device. Additionally internet radio may involve “set it and forget it” type listening in which listeners select a station, and the station may provide a continuous stream of audio that cannot be paused or replayed, much like traditional broadcast media. A user may select to listen to an internet radio station based on a wide range of criteria such as genre, artist, theme and other similar criteria, and the station may automatically select songs to play that match the selected criteria. Some stations may employ learning algorithms to select songs to play based on identifying musical attributes of songs, and taking into account user feedback in order to select songs that may be appealing to the user.

### SUMMARY

The present disclosure generally describes techniques to provide a network based broadcasting platform for streaming live media.

According to some examples, methods to stream live broadcast media are provided. An example method, executed at least in part on a computing device, may include retrieving media from a database of a media server in response to detecting a request for the media from a broadcaster, and streaming the media as a live broadcast at a first client device associated with the broadcaster. The example method may also include streaming the broadcast to a user at a second client device associated with the user in response to detecting a request from the user to subscribe to the broadcast; and displaying a broadcast page through a user interface of the first and second client devices to enable interaction between the user and the broadcaster.

According to other examples, media servers configured to stream live broadcast media are described. An example media sever may include a memory configured to store instructions, and a processor coupled to the memory, the processor executing an application in conjunction with instructions stored in the memory. The application may be configured to retrieve media from a database of the media server in response to detecting a request for the media from a broadcaster, and stream the media as a live broadcast at a first client device associated with the broadcaster. The application may further be configured to stream the broadcast to a user at a second client device associated with the user in response to detecting a request from the user to subscribe to the broadcast, and display a broadcast page through a user interface of the first and second client devices to enable interaction between the user and the broadcaster.

According to further examples, a computer-readable memory device with instructions stored thereon to stream live broadcast media is described. Example instructions may include retrieving media from a database of a media server in response to detecting a request for the media from a broadcaster, and streaming the media as a live broadcast at a first client device associated with the broadcaster. The example instructions may also include streaming the broadcast to a user at a second client device associated with the user in response to detecting a request from the user to subscribe to the broadcast, and displaying a broadcast page through a user interface of the first and second client devices to enable interaction between the user and the broadcaster. The example instructions may further include receiving user input associated with the streamed broadcast through the broadcast page displayed on the second client device associated with the user.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example networked environment where a media service platform to stream broadcast media may be implemented;

FIG. 2 illustrates another example networked environment where a media service platform to stream broadcast media may be implemented;

FIG. 3 illustrates an example user interface to enhance streaming of broadcast media;

FIG. 4 illustrates example preview mode panes displayed on a user interface for broadcasting media;

FIG. 5 illustrates a general purpose computing device, which may be used to stream a live media broadcast;

FIG. 6 is a flow diagram illustrating an example method to stream broadcast media that may be performed by a computing device such as the computing device in FIG. 5; and

FIG. 7 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to providing a network based broadcasting platform for streaming live media.

Briefly stated, technologies are generally described for a media service platform to stream broadcast media. A broadcaster may select media, such as audio and video recordings, to be included in a media broadcast. The media broadcast may be streamed to one or more subscribing users through one or more client devices over a network employing the media service platform. The subscribing users may be able to provide input and suggestions related to the streamed media through a broadcast page displayed on a user interface of the client devices. Additionally, the subscribing users may interact with each other and the broadcaster employing a real time discussion pane on the broadcast page. In some examples, the broadcaster may insert commentary and recordings concurrently with the streamed media broadcast. In other examples, the media broadcast may be saved and played again at a later time in part or in full.

The term “broadcast” as used herein may refer to live or non-live broadcast. Regular or non-live broadcast is broadcast on a website using content pulled from the site. An example of live broadcast may be a DJ who is playing music at a club in front of a live audience, and plugging in their soundboard into a computer and instantaneously streaming the content they are playing live at the club to the website, which makes the content available to users.

The terms subscriber and user are used interchangeably herein and may mean paying customers of a broadcasting website or non-paying users/subscribers who happen to tune in for a broadcast.

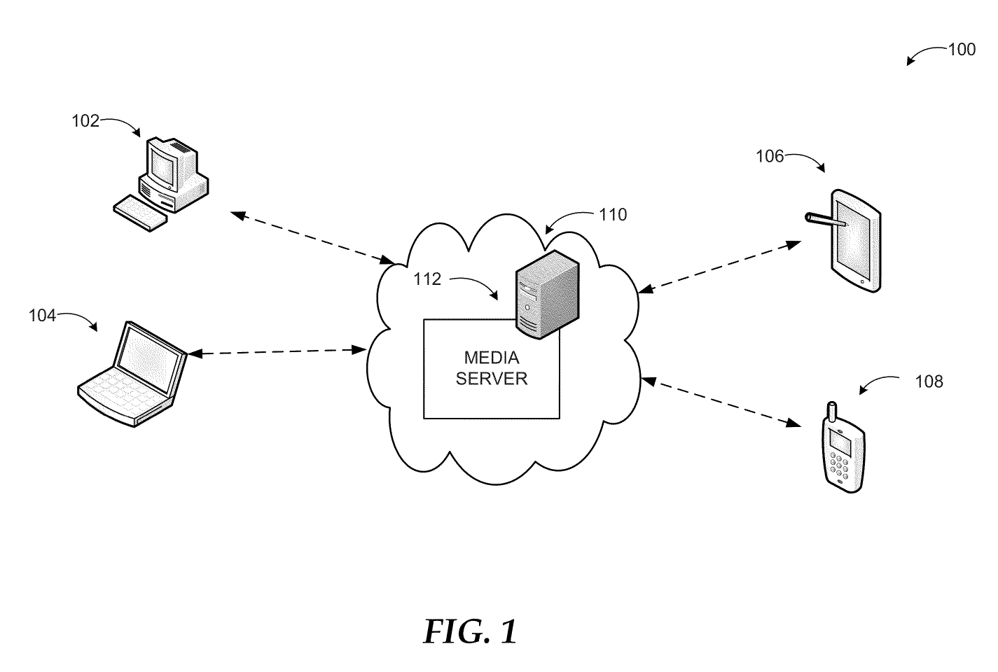

FIG. 1 illustrates an example networked environment where a media service platform to stream broadcast media may be implemented, arranged in accordance with at least some embodiments described herein.

As illustrated in diagram 100, a media server 112 may provide media, such as audio and video recordings, over a network 110 to a multitude of users. The network 110 may be a wired or wireless network, such as a cloud based network. The provided media may be streamed to one or more client devices where the users may listen to, view, and interact with the provided media. The users may be broadcaster or subscribing users, for example. Some example client devices enabling interaction with the provided media may include a desktop computing device 102, a personal computer 104, a tablet 106, a smart phone 108, and other similar client devices capable of receiving and playing media. A database of the media server 112 may store a catalog or library of media, and may enable the users to interact with the media server 112 over the network 110 to search for and request particular files based on various criteria such as keywords, titles, song names, artist, album, browsing friends' recent activity, and other similar criteria. The media server 112 may also enable users to create and edit playlists, or lists of selected media, such as songs and videos. Users may save their created playlists to a user account to enable future access and playback of the playlists. Additionally, the media server 112 may enable users to interact with other users over the network 110. For example, users may subscribe to other users' playlists and may share their created playlists through e-mail, social media, and other similar sharing services over the network 110. In other embodiments, the media server 112 may stream a concert or festival as broadcast media to the subscribing users.

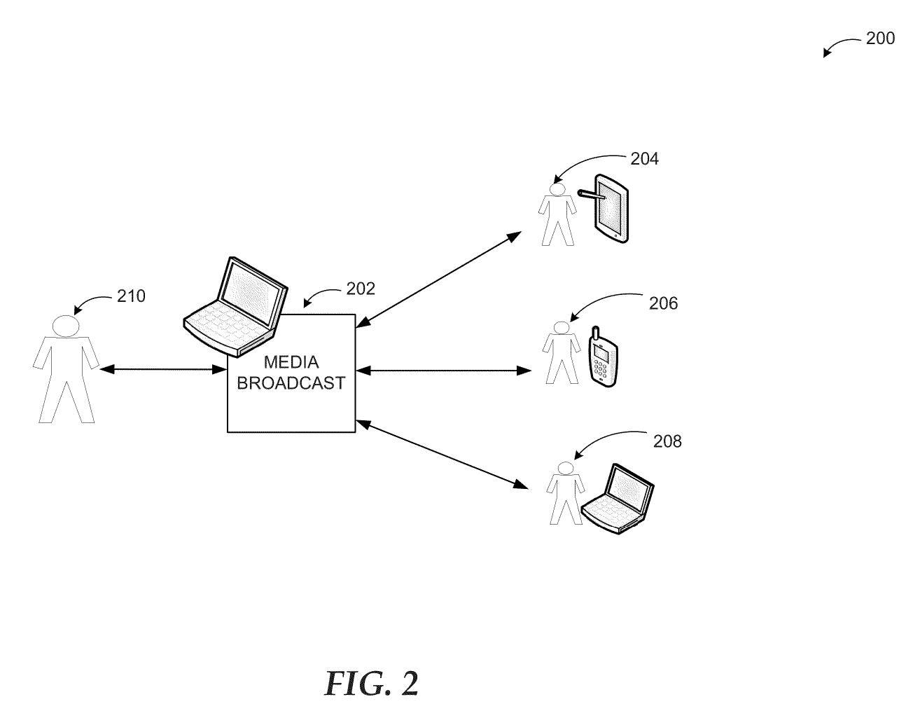

FIG. 2 illustrates another example networked environment where a media service platform to stream broadcast media may be implemented, arranged in accordance with at least some embodiments described herein.

In a system according to embodiments, as illustrated in diagram 200, a media service may enable a user acting as a disc jockey (DJ) or a broadcaster 210 to create and populate a music station with a selected list of songs, or other media, such as videos. The broadcaster 210 may be any user interacting with the media service to create playlists of selected media, for example. Live media from the created music station may be streamed to the broadcaster's client device as a media broadcast 202. The broadcaster 210 may use any client device such as a desktop computer, personal computer, smart phone, or tablet device to create and stream the media broadcast 202, and one or more subscribing users (e.g., users 204, 206, and 208) may stream and listen to the media broadcast 202 on any similar client device. In an example embodiment, the broadcaster 210 may actively select songs to play in the playlist from a database, such as a catalog or library of available media hosted by the media service. In another embodiment, the media service may pre-select and suggest one or more songs to the broadcaster 210, and the broadcaster 210 may choose to include the suggested song in the playlist for the media broadcast 202. Songs may be suggested employing selection algorithms which may select songs based on various criteria such as user ranking, votes, preferences, history, and other similar criteria.

In an example embodiment, while songs are streaming, the broadcaster 210 may be able to insert audio over the song. For example, the broadcaster may instantly record a mini track (for example, a recording of the broadcaster saying “This is your favorite broadcaster, check me out at 5 pm every day.”), and the broadcaster may input the recording into the queue for streaming between songs. In another example, the media service may enable overlapping channels such that the broadcaster 210 may record an audio or video recording to be played concurrently with a live streaming song. For example, the broadcaster 210 may speak into a microphone through a separate but parallel channel, which may be streamed with the media broadcast to subscribing users at the same time as a song currently playing. In another example, the broadcaster 210 may stream a live video image of himself, or other video image, while an audio recording of a song is streamed.

As previously described herein, a multitude of users may interact with the media service over a network. In a system according to embodiments, the broadcaster 210 may select to make his music selections available to subscribing users (e.g., users 204, 206, 208) interacting with the media service through the media broadcast 202. The users may search for a media broadcast by searching for a specified broadcaster. Additionally, users may search for a media broadcast employing other search techniques, such as searching by genre, theme, and/or by a keyword included in a user name, broadcast name, or song name. Users may also search for a particular song or video, and broadcasts that include the searched song or video in a playlist may be returned to the users.

The users may subscribe to the broadcaster's media broadcast 202 to listen to the broadcaster's selections, rather than actively selecting songs themselves or listening to media pre-selected for them by the media service based on the media service's selection algorithms. In an example scenario, a user may select to listen to the media broadcast 202, and after selecting the media broadcast 202, the user may listen to the music selections made by the broadcaster 210 in real time. The media broadcast 202 may be streamed in real time over a network to a client device associated with the subscribing user. In a further embodiment, the media broadcast 202 may be saved as a playlist, and the saved media broadcast 202 may be played back in part or in full at a later time.

In another example embodiment, the broadcaster 210 may select to make the media broadcast 202 available to one or more select users and/or groups based on customizable privacy settings. For example, the broadcaster 210 may make his broadcast available to one or more specified users, friends or users the broadcaster 210 is linked with on the media service, users registered with the media service, or the general public accessing the media service or network. The privacy settings may be customized according to the broadcaster's preferences.

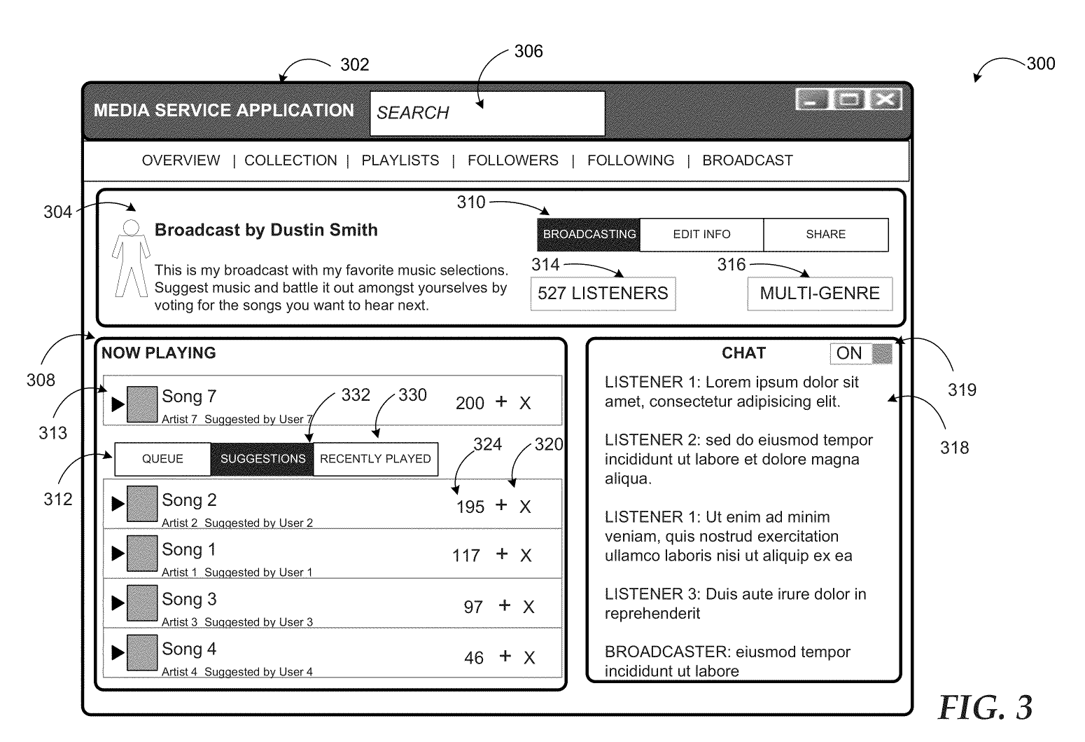

FIG. 3 illustrates an example user interface to enhance streaming of broadcast media, arranged in accordance with at least some embodiments described herein.

As previously described herein, one or more subscribing users may listen to a media broadcast of musical selections chosen by a broadcaster. The media broadcast may include a playlist of songs or other media, such as videos chosen by the broadcaster, to be streamed in real time over a network to the subscribing users.

In an example embodiment, as demonstrated in the diagram 300, a media service enabling real time media broadcasts of musical selections over a network may provide a user interface to enhance streaming of live media and user interaction. An example user interface may display a media broadcast page 302 to enable a broadcaster to manage the media broadcast, and to enable user interaction with the media broadcast. The media broadcast page 302 may display a broadcaster profile 304, which may include information about the broadcaster, and may be customizable by the broadcaster. The profile information may also include additional information about the broadcaster and/or the media broadcast, such as a number of current listeners 314, a number of total subscribers, a number of total plays, a genre 316 associated with the media broadcast, and other similar information. The broadcaster may select and customize the information to be included in the displayed broadcaster profile 304. Additionally, the media broadcast page 302 may include one or more selectable options 310 to enable the broadcaster to turn on and off the broadcast, to share the media broadcast, and to edit information included on the media broadcast page 302.

In a system according to embodiments, the media broadcast page 302 may also be displayed to the one or more users subscribing to the media broadcast. The media broadcast page 302 displayed to the one or more subscribing users may be a subscriber version of the media broadcast page 302 to enable the users to provide input and interact with other users and the broadcaster through the user interface. The subscriber version of the media broadcast page 302 may not include broadcaster control options, such as options to customize and turn on or off features as described herein.

In an example embodiment, a search pane 306 may be provided to enable the broadcaster to search for media to include in the media broadcast from a database, such as a catalog or library of media, provided by the media service. The broadcaster may search for media based on keywords, song name, artist, genre, and other similar search techniques. A list of media may be returned, and the broadcaster may select one or more returned results to be added to the media broadcast. In another example embodiment, the media for the live media broadcast may be provided by the broadcaster from a library of media hosted at the broadcaster's client device. For example, the broadcaster may create a playlist from media on the broadcaster's client device and stream the playlist from the broadcaster's client device through the media service, where other users may listen to the playlist over the network via the media service. Similarly, the search pane 306 may be displayed on the subscriber version of the media broadcast page 302 to enable subscribing users to search for media employing the search pane 306.

In another example embodiment, the media broadcast page 302 may display a playlist 308 of media selections the broadcaster has selected for the live media broadcast. The playlist may display a currently playing 313 song, as well as a queue 312 of songs, or other media, to be played next. The playlist may also include an option to display a list of recently played 330 songs. In some examples, users may be enabled to tell which song was playing when a chat message was sent from a chat pane. For example, if someone at some point in the chat says “I love this song” but it was 10 minutes ago, a user may be able to tell which song that person was listening to when they sent the chat. Moreover, the user may add the song to his or her library collection or favorites at that point.

In a further embodiment, subscribing users may provide feedback to the broadcaster such as suggesting songs, rating songs, and up and/or down-voting songs. For example, a subscribing user may make requests and suggest songs to the broadcaster, and a list of suggested songs 332 may be presented in the playlist 308. The playlist 308 may also display selectable buttons 320 to enable subscribing users to vote up or vote down an existing song on the list of suggested songs, and a weighted 324 list of suggested songs may be presented based on the listener votes. In some example scenarios, if a threshold number of subscribing users vote up a song that has been suggested, the suggested song may automatically become the next song to be played.

In another embodiment, the media service may enable the subscribing users to interact with and chat with other users and the broadcaster. A discussion pane 318 may be provided on the media broadcast page 302 where the subscribing users may chat with other users in real time while listening to the media broadcast. An option 319 may be provided to enable the broadcaster to enable or disable the discussion pane 318. In some examples, subscribing users may be able to view and follow profiles associated with the other users by selecting the username from the discussion pane 318. Additionally, subscribing users may be able to invite other users to join the broadcast and/or the discussion employing email, text, and social media platforms.

In a system according to embodiments, the broadcaster may customize features of the media broadcast page 302 for the media broadcast. Customizable features may include, but are not limited to, selecting a background and graphical and textual schemes, and creating descriptions and content for the media broadcast page 302. The broadcaster may also customize broadcast settings such as enabling and disabling particular features such as comments, chatting, song suggestions, and song ratings, for example. Additionally, the broadcaster may select privacy settings for the media broadcast to control the accessibility of the media broadcast. Furthermore, in some embodiments, multiple broadcasters may have broadcasting privileges, such that two or more broadcasters may concurrently manage and control the live media broadcast. The two or more broadcasters may manage the live media broadcast from a same client device, or in other embodiments, the two or more broadcasters may control the media broadcast from separate client devices in separate locations. The primary broadcaster may enable temporary broadcaster privileges to allow for another user to participate as a temporary broadcaster.

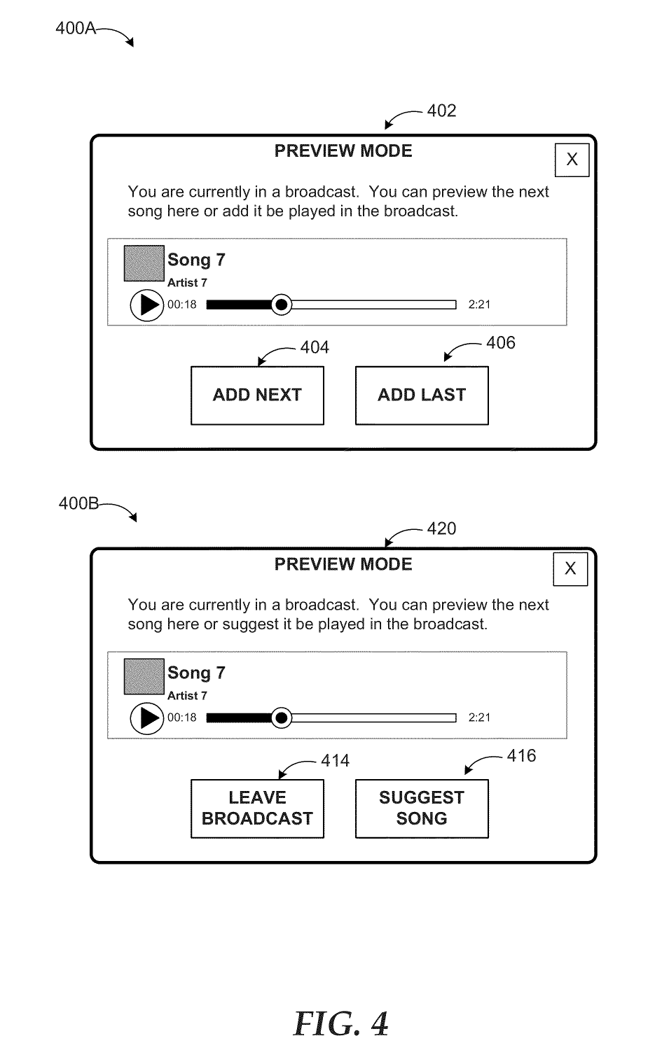

FIG. 4 illustrates example preview mode panes displayed on a user interface for broadcasting media, arranged in accordance with at least some embodiments described herein.

Diagram 400A demonstrates a broadcaster preview pane 402, where a broadcaster may preview a song. For example, while the broadcaster is currently streaming a broadcast, the broadcaster may search for a song. The broadcaster may select the song, and the broadcaster preview pane 402 may be displayed as a pop-up pane to enable the broadcaster to listen to the song without streaming the song to other listeners. In some examples, when the broadcaster preview pane 402 is initially displayed, the song may automatically begin playing. The broadcaster preview pane 402 may enable the broadcaster to add the song to the playlist, by adding the song to be played next 404 or to be played at the end 406 of the current playlist queue, for example.

Diagram 400B demonstrates a user preview pane 420. The user preview pane 420 may also be a pop-up pane that may be displayed when a subscribing user selects a song from the playlist or from a returned list of searched songs. The user preview pane 420 may enable the subscribing user to suggest 416 to add the previewed song to the current media broadcast, or to leave 414 the media broadcast.

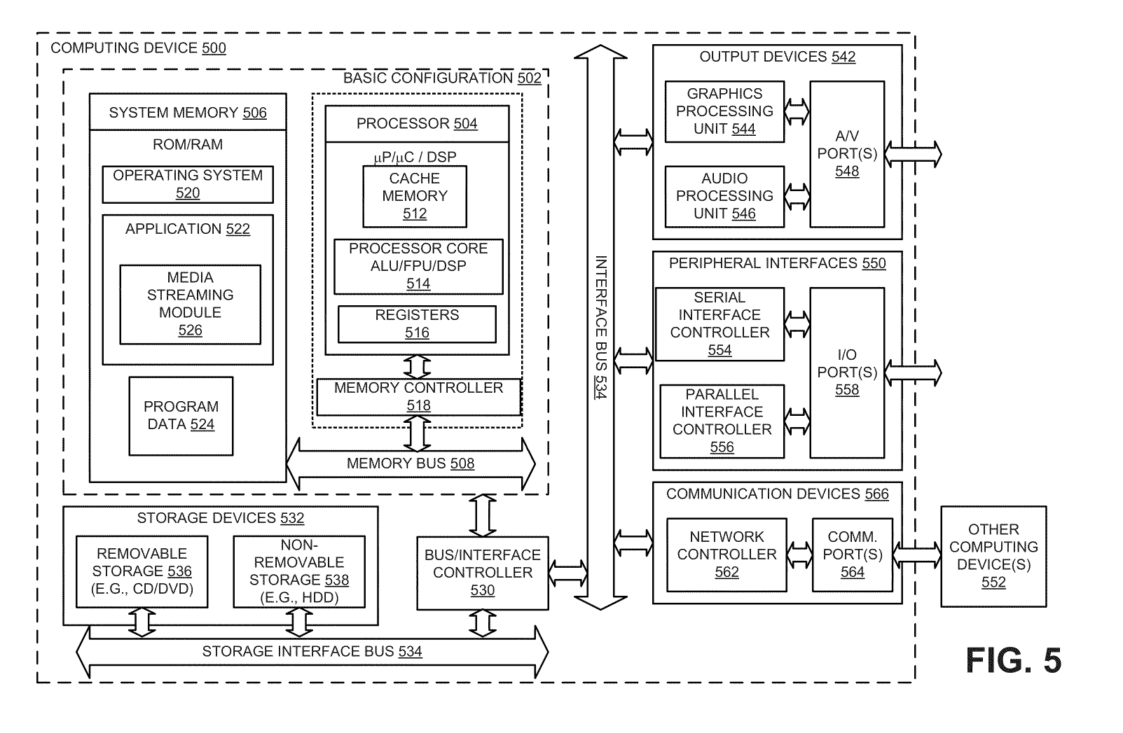

FIG. 5 illustrates a general purpose computing device, which may be used to stream a live media broadcast, arranged in accordance with at least some embodiments as described herein.

For example, a computing device 500 may be used as a server, desktop computer, portable computer, smart phone, special purpose computer, or similar device. In an example basic configuration 502, the computing device 500 may include one or more processors 504 and a system memory 506. A memory bus 508 may be used for communicating between the processor 504 and the system memory 506. The basic configuration 502 is illustrated in FIG. 5 by those components within the inner dashed line.

Depending on the desired configuration, the processor 504 may be of any type, including but not limited to a microprocessor (μP), a microcontroller (μC), a digital signal processor (DSP), or any combination thereof. The processor 504 may include one more levels of caching, such as a level cache memory 512, one or more processor cores 514, and registers 516. The example processor cores 514 may (each) include an arithmetic logic unit (ALU), a floating point unit (FPU), a digital signal processing core (DSP Core), or any combination thereof. An example memory controller 518 may also be used with the processor 504, or in some implementations, the memory controller 518 may be an internal part of the processor 504.

Depending on the desired configuration, the system memory 506 may be of any type including but not limited to volatile memory (such as RAM), non-volatile memory (such as ROM, flash memory, etc.) or any combination thereof. The system memory 506 may include an operating system 520, a media broadcast application 522, and program data 524. The media broadcast application 522 may include a media streaming module 526, which may be an integral part of the media broadcast application 522 or a separate application on its own.

The media streaming module 526 may enable a broadcaster to select media to be included in a playlist for live media broadcast, and stream the broadcast over a network to one or more subscribing users. Program data 524 may include, among other data, media data for selected songs and user data for users subscribing to a live media broadcast, for example, as described herein.

The computing device 500 may have additional features or functionality, and additional interfaces to facilitate communications between the basic configuration 502 and any desired devices and interfaces. For example, a bus/interface controller 530 may be used to facilitate communications between the basic configuration 502 and one or more data storage devices 532 via a storage interface bus 534. The data storage devices 532 may be one or more removable storage devices 536, one or more non-removable storage devices 538, or a combination thereof. Examples of the removable storage and the non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 506, the removable storage devices 536 and the non-removable storage devices 538 are examples of computer storage media. Computer storage media includes, but is not limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (for example, one or more output devices 542, one or more peripheral interfaces 550, and one or more communication devices 566) to the basic configuration 502 via the bus/interface controller 530. Some of the example output devices 542 include a graphics processing unit 544 and an audio processing unit 546, which may be configured to communicate to various external devices such as a display or speakers via one or more A/V ports 548. One or more example peripheral interfaces 550 may include a serial interface controller 554 or a parallel interface controller 556, which may be configured to communicate with external devices such as input devices (for example, keyboard, mouse, pen, voice input device, touch input device, etc.) or other peripheral devices (for example, printer, scanner, etc.) via one or more I/O ports 558. An example communication device 566 includes a network controller 562, which may be arranged to facilitate communications with one or more other computing devices 552 over a network communication link via one or more communication ports 564. The one or more other computing devices 552 may include servers, client devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 500 may be implemented as a part of a general purpose or specialized server, mainframe, or similar computer that includes any of the above functions. The computing device 500 may also be implemented as a personal computer including both laptop computer and non-laptop computer configurations.

Example embodiments may also include methods to stream live media broadcast. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

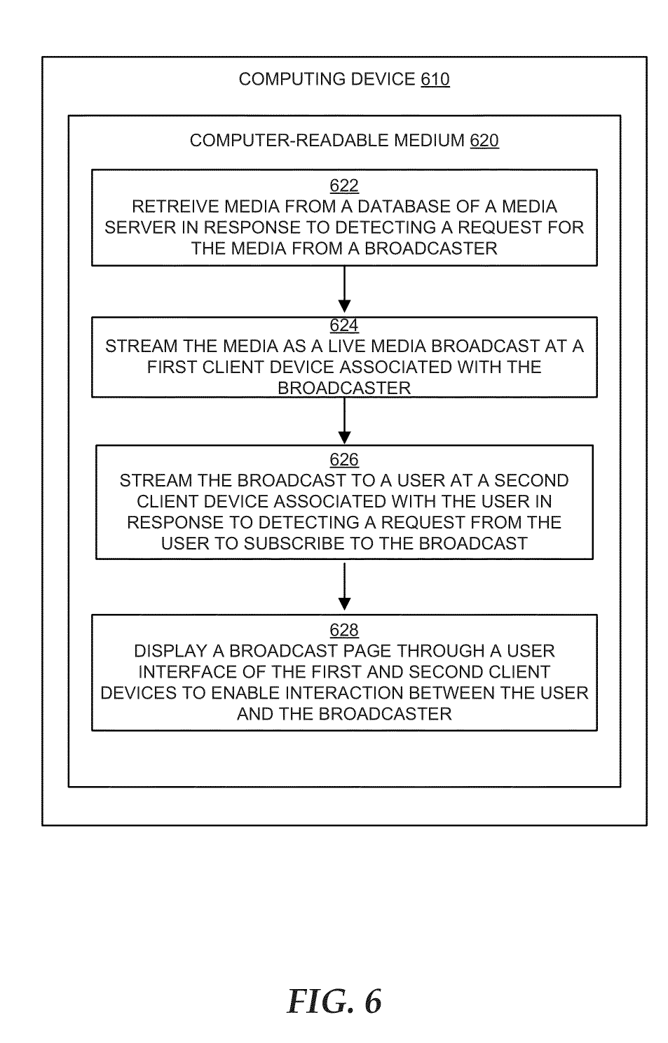

FIG. 6 is a flow diagram illustrating an example method to stream broadcast media that may be performed by a computing device such as the computing device in FIG. 5, arranged in accordance with at least some embodiments as described herein.

Example methods may include one or more operations, functions or actions as illustrated by one or more of blocks 622 through 628, and may in some embodiments be performed by a computing device such as the computing device 500 in FIG. 5. The operations described in the blocks 622 through 628 may also be implemented through execution of computer-executable instructions stored in a non-transitory computer-readable medium, such as a computer-readable medium 620 of a controller device 610, and executable by one or more processors. In other embodiments, the various operations may be implemented/provided using methods alternatively or in addition to the execution of computer-executable instructions.

An example process for streaming a live media broadcast may begin with block 622, “RETREIVE MEDIA FROM A DATABASE OF A MEDIA SERVER IN RESPONSE TO DETECTING A REQUEST FOR THE MEDIA FROM A BROADCASTER,” where a broadcaster may request one or more media files, such as songs and videos, to be included in a playlist for the live media broadcast. The media files may be requested from a media service providing a platform for the live media broadcast. The media service may retrieve the requested media from a database, such as a media library or catalog, hosted by the media service. The retrieved media may be included in a playlist for the live media broadcast.

Block 622 may be followed by block 624, “STREAM THE MEDIA AS A LIVE MEDIA BROADCAST AT A FIRST CLIENT DEVICE ASSOCIATED WITH THE BROADCASTER,” where the retrieved media may be streamed to the broadcaster's client device as a live media broadcast.

Block 624 may be followed by block 626, “STREAM THE BROADCAST TO A USER AT A SECOND CLIENT DEVICE ASSOCIATED WITH THE USER IN RESPONSE TO DETECTING A REQUEST FROM THE USER TO SUBSCRIBE TO THE BROADCAST,” where the live media broadcast may be streamed at a client device associated with a user subscribing to the broadcast. The user may subscribe to the broadcast over a network via the media service. The streamed live media broadcast may include a currently playing song, and a queue of songs to be played next in an order specified by the broadcaster.

Block 626 may be followed by block 628, “DISPLAY A BROADCAST PAGE THROUGH A USER INTERFACE OF THE FIRST AND SECOND CLIENT DEVICES TO ENABLE INTERACTION BETWEEN THE USER AND THE BROADCASTER,” where the subscribing user and the broadcaster may interact with the live media broadcast to provide input related to features of the live media broadcast and the streamed media via a broadcast page displayed through a user interface of the respective client devices. For example, a broadcaster version of the broadcast page may be displayed through the user interface of the first client device associated with the broadcaster, enabling the broadcaster to manage the media broadcast. Accordingly, a subscriber version of the broadcast page may be displayed through the user interface of the second client device associated with the user subscribing to the broadcast, enabling the users to provide input and interact with other users and the broadcaster through the user interface. The user may suggest songs or other media selections, vote up and/or vote down a media selection, and provide similar input related to streamed media, for example. The user may also search for and preview songs to suggest to be included in the life media broadcast. In some embodiments, the user may interact with one or more other subscribing users during the live media broadcast via the user interface. The users may chat with each other via a discussion pane, view other users' profiles, and invite other users to join the broadcast and the discussion employing email, text, social media, and other similar platforms, for example.

The blocks included in the above described process are for illustration purposes. Enabling a user to stream a live media broadcast via a media service may be implemented by similar processes with fewer or additional blocks. In some embodiments, the blocks may be performed in a different order. In some other embodiments, various blocks may be eliminated. In still other embodiments, various blocks may be divided into additional blocks, or combined together into fewer blocks.

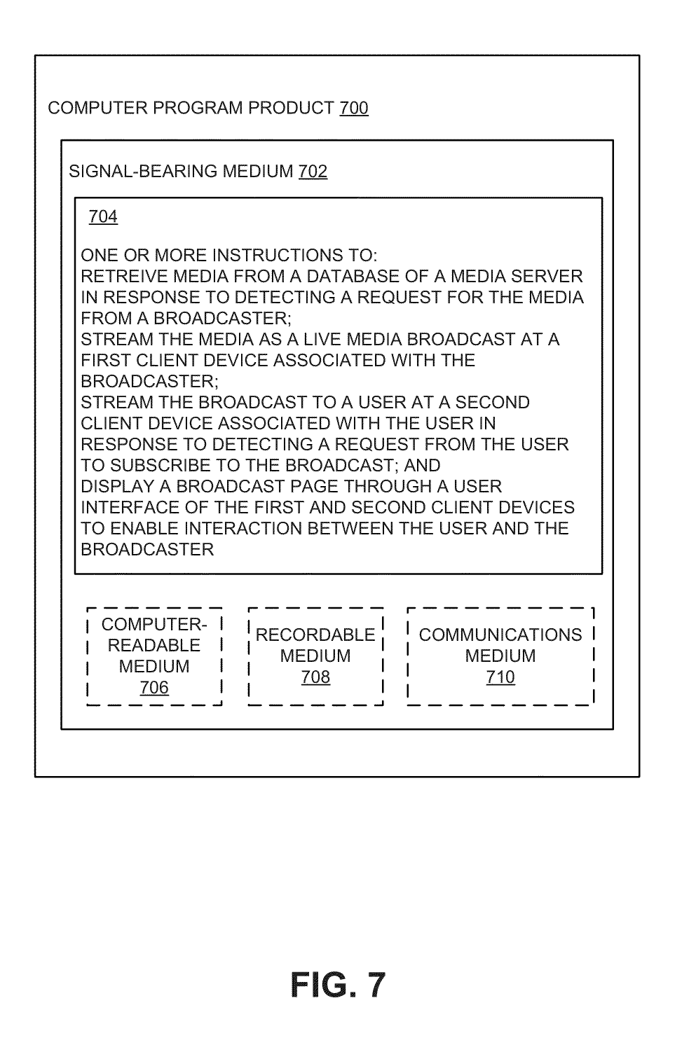

FIG. 7 illustrates a block diagram of an example computer program product, arranged in accordance with at least some embodiments as described herein.

In some embodiments, as shown in FIG. 7, the computer program product 700 may include a signal bearing medium 702 that may also include one or more machine readable instructions 704 that, when executed by, for example, a processor may provide the functionality described herein. Thus, for example, referring to the processor 504 in FIG. 5, a media streaming module 526 executed on the processor 504 may undertake one or more of the tasks shown in FIG. 7 in response to the instructions 704 conveyed to the processor 504 by the medium 702 to perform actions associated with enabling a broadcaster to select media to be included in a playlist for streaming a live media broadcast to subscribing users as described herein. Some of those instructions may include, for example, instructions to retrieve media from a database of a media server in response to detecting a request for the media from a broadcaster, stream the media as a live media broadcast at a first client device associated with the broadcaster, stream the broadcast to a user at a second client device associated with the user in response to detecting a request form the user to subscribe to the broadcast, and display a broadcast page through a user interface of the first and second client devices to enable interaction between the user and the broadcaster, according to some embodiments described herein.

In some implementations, the signal bearing medium 702 depicted in FIG. 7 may encompass a computer-readable medium 706, such as, but not limited to, a hard disk drive, a solid state drive, a Compact Disc (CD), a Digital Versatile Disk (DVD), a digital tape, memory, etc. In some implementations, the signal bearing medium 702 may encompass a recordable medium 708, such as, but not limited to, memory, read/write (R/W) CDs, R/W DVDs, etc. In some implementations, the signal bearing medium 702 may encompass a communications medium 710, such as, but not limited to, a digital and/or an analog communication medium (for example, a fiber optic cable, a waveguide, a wired communications link, a wireless communication link, etc.). Thus, for example, the program product 700 may be conveyed to one or more modules of the processor 504 of FIG. 5 by an RF signal bearing medium, where the signal bearing medium 702 is conveyed by the wireless communications medium 710 (for example, a wireless communications medium conforming with the IEEE 702.11 standard).

According to some examples methods to stream live broadcast media are provided. An example method, executed at least in part on a computing device, may include retrieving media from a database of a media server in response to detecting a request for the media from a broadcaster, and streaming the media as a live broadcast at a first client device associated with the broadcaster. The example method may also include streaming the broadcast to a user at a second client device associated with the user in response to detecting a request from the user to subscribe to the broadcast; and displaying a broadcast page through a user interface of the first and second client devices to enable interaction between the user and the broadcaster.

In other examples, user input associated with the streamed broadcast media may be received through the second client device. Displaying the broadcast page may include displaying a broadcaster profile, a playlist of streamed media, a currently playing selection, a queue of media to be played next, a list of recently streamed media, a list of suggested media, a search pane, and/or a discussion pane. Displaying the broadcast page may also include displaying a broadcaster version of the broadcast page through the user interface of the first client device associated with the broadcaster and a subscriber version of the broadcast page through the user interface of the second client device associated with the user, where the broadcaster version may include one or more broadcaster control options enabling the broadcaster to manage the broadcast media.

In further examples, the broadcaster may be enabled to customize one or more features of the displayed broadcast page. The broadcaster may also be enabled to select privacy settings for the broadcast media to control accessibility of the broadcast media. The user may be enabled to suggest a media selection to the broadcaster. The user may also be enabled to rate, vote up, and/or vote down a currently playing media selection. The user may further be enabled to chat with the broadcaster and one or more other users employing a discussion pane displayed on the user interface.

According to some embodiments, media servers configured to stream live broadcast media are described. An example media sever may include a memory configured to store instructions, and a processor coupled to the memory, the processor executing an application in conjunction with instructions stored in the memory. The application may be configured to retrieve media from a database of the media server in response to detecting a request for the media from a broadcaster, and stream the media as a live broadcast at a first client device associated with the broadcaster. The application may further be configured to stream the broadcast to a user at a second client device associated with the user in response to detecting a request from the user to subscribe to the broadcast, and display a broadcast page through a user interface of the first and second client devices to enable interaction between the user and the broadcaster.

In other embodiments, the broadcaster may be a media selecting user interacting with a media service. The application may be further configured to enable the broadcaster to insert commentary into the streamed broadcast media. The application may be further configured to enable the broadcaster to record an audio or video recording that includes the commentary, and insert the recording into a queue of the broadcast media for streaming. Additionally, the application may be further configured to enable the broadcaster to insert the commentary into a live separate stream that is parallel to the streamed broadcast such that the commentary is played concurrently with the streamed broadcast in real time.

In further embodiments, the broadcast page may include: a broadcaster profile, a playlist of streamed media, a currently playing selection, a queue of media to be played next, a list of recently streamed media, a list of suggested media, a search pane, and/or a discussion pane. The application may be further configured to enable the broadcaster to manage the streamed broadcast media through a broadcaster version of the broadcast page displayed through the user interface of the first client device associated with the broadcaster, where the broadcaster version of the broadcast page may include one or more control options enabling management and customization of the broadcast media.

According to some examples, a computer-readable memory device with instructions stored thereon to stream live broadcast media is described. Example instructions may include retrieving media from a database of a media server in response to detecting a request for the media from a broadcaster, and streaming the media as a live broadcast at a first client device associated with the broadcaster. The example instructions may also include streaming the broadcast to a user at a second client device associated with the user in response to detecting a request from the user to subscribe to the broadcast, and displaying a broadcast page through a user interface of the first and second client devices to enable interaction between the user and the broadcaster. The example instructions may further include receiving user input associated with the streamed broadcast through the broadcast page displayed on the second client device associated with the user.

In other examples, a preview pane may be provided to enable a preview of a media selection while the broadcast media is streaming. The example instructions may also include enabling the broadcaster to customize a textual and graphical scheme of the broadcast page.

There are various vehicles by which processes and/or systems and/or other technologies described herein may be effected (for example, hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, may be equivalently implemented in integrated circuits, as one or more computer programs running on one or more computers (for example, as one or more programs running on one or more computer systems), as one or more programs running on one or more processors (for example as one or more programs running on one or more microprocessors), as firmware, or as virtually any combination thereof, and that designing the circuitry and/or writing the code for the software and or firmware would be possible in light of this disclosure.

The present disclosure is not to be limited in terms of the particular embodiments described in this application, which are intended as illustrations of various aspects. Many modifications and variations can be made without departing from its spirit and scope Functionally equivalent methods and apparatuses within the scope of the disclosure, in addition to those enumerated herein, will be possible from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, systems, or components, which can, of course, vary. It is also to be understood that the terminology used herein is for the purpose of describing particular embodiments only, and is not intended to be limiting.

In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (for example, a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops.

A typical data processing system may be implemented utilizing any suitable commercially available components, such as those typically found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that particular functionality is achieved. Hence, any two components herein combined to achieve a particular functionality may be seen as “associated with” each other such that the particular functionality is achieved, irrespective of architectures or intermediate components. Likewise, any two components so associated may also be viewed as being “operably connected”, or “operably coupled”, to each other to achieve the particular functionality, and any two components capable of being so associated may also be viewed as being “operably couplable”, to each other to achieve the particular functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method executed at least in part on a computing device to stream broadcast media, the method comprising:
retrieving media from a database of a media server in response to detecting a request for the media from a broadcaster;
streaming the media as a broadcast at a first client device associated with the broadcaster;
streaming the broadcast to a user at a second client device associated with the user in response to detecting a request from the user to subscribe to the broadcast; and
displaying a broadcast page through a user interface of the first and second client devices to enable interaction between the user and the broadcaster.

2. The method of claim 1, further comprising:
receiving user input associated with the streamed broadcast media through the second client device.

3. The method of claim 1, wherein displaying the broadcast page comprises:
displaying one or more of: a broadcaster profile, a playlist of streamed media, a currently playing selection, a queue of media to be played next, a list of recently streamed media, a list of suggested media, a search pane, and a discussion pane.

4. The method of claim 1, wherein displaying the broadcast page further comprises:
displaying a broadcaster version of the broadcast page through the user interface of the first client device associated with the broadcaster and a subscriber version of the broadcast page through the user interface of the second client device associated with the user, wherein the broadcaster version includes one or more broadcaster control options enabling the broadcaster to manage the broadcast media.

5. The method of claim 1, further comprising:
enabling the broadcaster to customize one or more features of the displayed broadcast page.

6. The method of claim 1, further comprising:
enabling the broadcaster to select privacy settings for the broadcast media to control accessibility of the broadcast media.

7. The method of claim 1, further comprising:
enabling the user to suggest a media selection to the broadcaster.

8. The method of claim 7, further comprising:
enabling the user to one of: rate, vote up, or vote down a currently playing media selection.

9. The method of claim 1, further comprising:
enabling the user to chat with the broadcaster and one or more other users employing a discussion pane displayed on the user interface.

10. A media server configured to stream broadcast media, the media server comprising:
a memory configured to store instructions;
a processor coupled to the memory, the processor executing an application in conjunction with instructions stored in the memory, wherein the application is configured to:
retrieve media from a database of the media server in response to detecting a request for the media from a broadcaster;
stream the media as a broadcast at a first client device associated with the broadcaster;
stream the broadcast to a user at a second client device associated with the user in response to detecting a request from the user to subscribe to the broadcast; and
display a broadcast page through a user interface of the first and second client devices to enable interaction between the user and the broadcaster.

11. The media server of claim 10, wherein the broadcaster is a media selecting user interacting with a media service.

12. The media server of claim 10, wherein the application is further configured to:
enable the broadcaster to insert commentary into the streamed broadcast media.

13. The media server of claim 12, wherein the application is further configured to:
enable the broadcaster to record one of an audio or video recording that includes the commentary; and
insert the recording into a queue of the broadcast media for streaming.

14. The media server of claim 12, wherein the application is further configured to:
enable the broadcaster to insert the commentary into a live separate stream that is parallel to the streamed broadcast such that the commentary is played concurrently with the streamed broadcast in real time.

15. The media server of claim 10, wherein the broadcast page includes one or more of: a broadcaster profile, a playlist of streamed media, a currently playing selection, a queue of media to be played next, a list of recently streamed media, a list of suggested media, a search pane, and a discussion pane.

16. The media server of claim 15, wherein the application is further configured to enable the broadcaster to manage the streamed broadcast media through a broadcaster version of the broadcast page displayed through the user interface of the first client device associated with the broadcaster, wherein the broadcaster version of the broadcast page includes one or more control options enabling management and customization of the broadcast media.

17. A computer-readable memory device with instructions stored thereon to stream broadcast media, the instructions comprising:
retrieving media from a database of a media server in response to detecting a request for the media from a broadcaster;
streaming the media as a broadcast at a first client device associated with the broadcaster;
streaming the broadcast to a user at a second client device associated with the user in response to detecting a request from the user to subscribe to the broadcast;
displaying a broadcast page through a user interface of the first and second client devices to enable interaction between the user and the broadcaster; and
receiving user input associated with the streamed broadcast through the broadcast page displayed on the second client device associated with the user.

18. The computer-readable memory device of claim 17, wherein the instructions further comprise:
providing a preview pane to enable a preview of a media selection while the broadcast media is streaming.

19. The computer-readable memory device of claim 17, wherein the instructions further comprise:
enabling the broadcaster to customize a textual and graphical scheme of the broadcast page.
